(19) United States
(12) Patent Application Publication
(10) Pub. No.: US 2009/0235186 A1
(43) Pub. Date: Sep. 17, 2009

(54) LIMITED-SCOPE RENDERING

(75) Inventors: Robert McKee Howard, Seattle, WA (US); Andrei V. Chtcherbatchenko, Redmond, WA (US); Alexander Hussain Malek, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/047,306

(22) Filed: Mar. 12, 2008

(51) Int. Cl. G06F 3/048

(52) U.S. Cl. 715/760

(57) ABSTRACT

Technologies and concepts are presented herein for limited-scope rendering of a document, such as a Web page, which contains code that when rendered or executed generates one or more graphical page elements. A user interface is provided through which a scope within the code or page elements may be specified. A request may also be received to zoom into the selected scope. In response to such a request, only the code and/or page elements within the specified scope are rendered, displayed, and made available for editing. Code and page elements outside the specified scope are not rendered or displayed. In response to a request to zoom out from the selected scope, all of the code and page elements are rendered and displayed.

### BACKGROUND

When creating and editing complex World Wide Web (“Web”) pages, it is often the case that a user is only interested in working on a particular portion of the Web page. For example, during a particular editing session, a user may focus their efforts on editing the page navigation content within a Web page. During another session, the user may focus their efforts on editing the main content of the Web page.

When a user is focused on editing a particular portion of a complex Web page, the remaining but currently unimportant content of the Web page can diminish the editing experience in several ways. For instance, the currently unimportant content on the Web page may be distracting to the user. Moreover, displaying the unimportant content requires a portion of the display screen, thereby causing the particular portion of the Web page being edited to be rendered in a smaller area. Additionally, the performance of the editor program utilized to edit the Web page may be reduced because of the resources needed to render the currently unimportant Web page content.

It is with respect to these considerations and others that the disclosure made herein is presented.

### SUMMARY

Technologies and concepts are presented herein for limited-scope rendering of a document, such as a Web page. In particular, through the use of the embodiments presented herein, the scope of a Web page rendered and displayed by an editor program can be limited to a specific code or page element defined by the Web page. Rendering and displaying only the desired portion of the Web page simplifies the editing experience, maximizes the available area of a screen display, and may improve the performance of the editor program by allowing the program to only render the desired element.

According to one aspect presented herein, an editor program provides functionality for editing a document, such as a Web page, that contains code that when rendered or executed generates one or more graphical page elements. In one implementation, the editor program provides a split view user interface for editing a Web page. The split view user interface includes a first section that shows the code of the Web page and a second section that is utilized to display the rendered graphical page elements. The editor program provides functionality for editing the code and the page elements.

According to other aspects, the editor program also provides functionality for “zooming” into a specified scope within the code or the displayed page elements. As described herein, the term zooming refers to the process of rendering and displaying only a specified scope within the code and/or page elements. For instance, in one implementation, a user may select one of the page elements in the split view user interface and request to “zoom” into the page element. In response to such a request, the editor program renders and displays only the selected page element in the second section of the user interface. Additionally, only the code responsible for generating the selected page element is displayed and made available for editing in the first section of the user interface. Code and page elements outside the specified scope are not rendered or displayed. In one implementation, the selected page element is rendered in a manner that fills the entire second section of the user interface, thereby maximizing the use of the available display area. At any time, the user may request to zoom out of the selected page element, thereby showing all of the code and page elements.

According to another aspect, a user may also select a portion of the code displayed in the first portion of the split view user interface and request to zoom into the selected code. For instance, the selected portion may comprise code for generating one of the page elements. In response thereto, the editor program displays only the selected code in the first section of the user interface. The editor program also renders and displays only the page element, or elements, generated by the selected code in the second section of the user interface. The user may request to zoom out of the selected code, thereby showing all of the code and page elements.

According to another aspect, the editor program also provides a code view user interface and a design view user interface. The code view user interface provides a single display section for showing the code, but does not display the rendered graphical page elements as in the split view user interface. The design view user interface provides a single display section for showing the rendered graphical page elements, but does not display the code. According to aspects, functionality is provided for zooming into a selected scope of code within the code view user interface and for zooming into a page element shown in the design view user interface. When the user interface is zoomed into the code or a page element and a transition is made between the split view, code view, and design view user interfaces, only the zoomed code or page element is displayed in each of the user interfaces. In this manner, a user can utilize each of the user interfaces while remaining zoomed in to the specified code or page element.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network diagram showing aspects of an illustrative operating environment and several software components provided by the embodiments presented herein;

FIGS. 2-7 are screen diagrams illustrating aspects of a user interface for limited-scope rendering provided by embodiments presented herein;

FIG. 8 is a flow diagram showing a method for limited-scope rendering in one embodiment presented herein; and

FIG. 9 is a computer architecture diagram showing an illustrative computer hardware and software architecture for a computing system capable of implementing aspects of the embodiments presented herein.

### DETAILED DESCRIPTION

The following detailed description is directed to technologies for limited scope rendering. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for limited-scope rendering will be described.

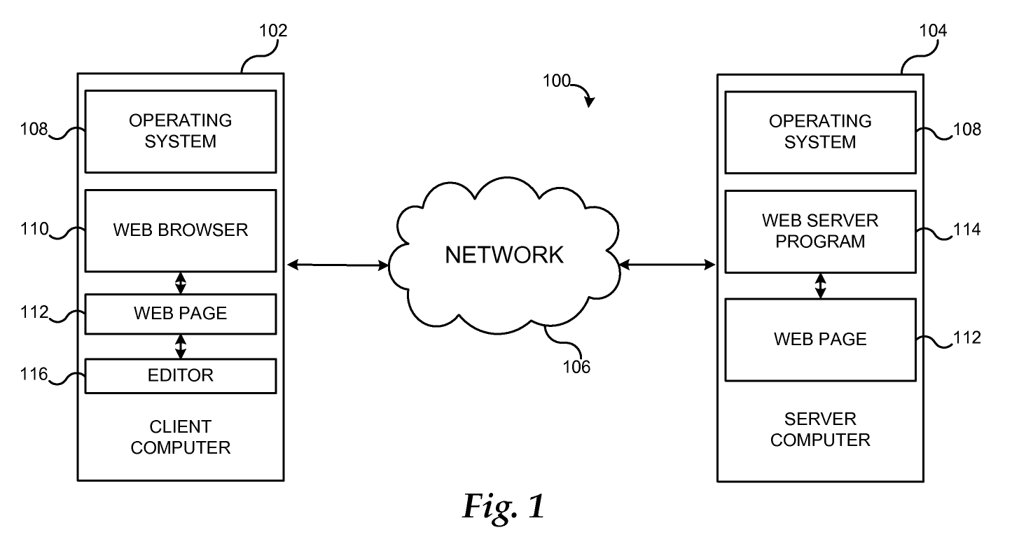

Turning now to FIG. 1, details will be provided regarding an illustrative operating environment and several software components provided by the embodiments presented herein. In particular, FIG. 1 shows aspects of a computing system 100 for limited-scope rendering. The system 100 includes a client computer 102 and a server computer 104. As illustrated in FIG. 1, the client computer 102 and the server computer 104 are interconnected through one or more local or wide area networks, such as the network 106. It should be appreciated that many more and different network connections may be utilized than those illustrated in FIG. 1.

In one embodiment, the client computer 102 illustrated in FIG. 1 comprises a standard desktop or laptop computer system capable of executing an operating system and one or more application programs. In particular, according to embodiments, the client computer 102 is operative to execute an operating system 108 suitable for controlling the operation of a general-purpose desktop computing system. The server computer 104 is also operative to execute an operating system 108 suitable for controlling the operation of a server computing system. It should be appreciated that the computing systems shown in FIG. 1 and described herein are merely illustrative and that the embodiments presented herein may be utilized with virtually any type of computing system, including but not limited to desktop, portable, server, ultra-mobile, and handheld computing devices.

According to embodiments, the client computer 102 is also operative to execute a Web browser program 110. As known in the art, the Web browser program 110 is capable of communicating with a Web server program 114 executing on the server computer 104 to retrieve, render, and display a Web page 112 and any associated resources at the client computer 102. A Web page, such as the Web page 112, is a resource of information that is suitable for delivery via the World Wide Web (e.g. via the Hypertext Transfer Protocol (“HTTP”)). For instance, the Web page 112 may comprise a document that includes code which, when rendered and/or executed at the client computer 102 or the server computer 104, generates one or more graphical page elements. Page elements are any graphical object that can be rendered and displayed by a Web browser.

It should be appreciated that, according to embodiments, the Web page 112 may contain markup language code, such as the Hypertext Markup Language (“HTML”), and/or program code, including but not limited to scripts or other types of executable or interpretable program code. For instance, the Web page 112 may include ASP.NET code, JAVASCRIPT, Extensible Style Sheet Language (“XSL”) code, Cascading Style Sheet (“CSS”) code, FLASH or SILVERLIGHT code, or others. Accordingly, the term “code” as used herein includes any data that can be rendered, executed, interpreted, or otherwise utilized to generate a page element. It should be appreciated that the Web page 112 may also be stored statically or generated dynamically by the Web server program 114, and may include content that is contributed from other Web pages, such as a template or master page, off of which the Web page 112 is based.

According to aspects, the client computer 102 may also be configured to execute an editor program 116 (referred to herein as the “editor”). The editor 116 is a program that includes functionality for creating and editing Web pages, such as the Web page 112. Through the functionality provided by the editor 116, a user can retrieve the Web page 112 from the server computer 104, edit the Web page 112, and store the edited Web page 112 back to the server computer 104. The Web server program 114 may then deliver the edited Web page 112 to the Web browser program 110 executing on the client computer 102 and to other client computers.

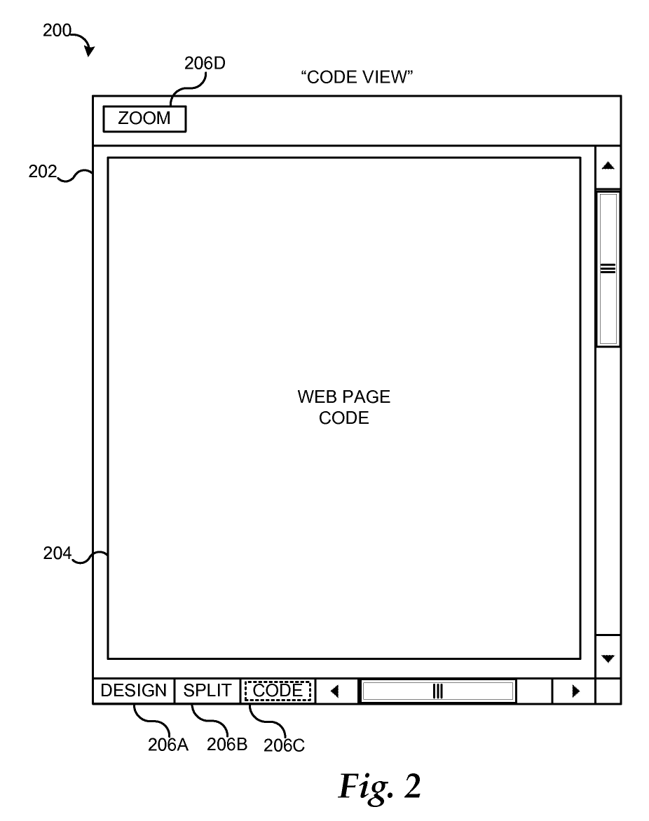

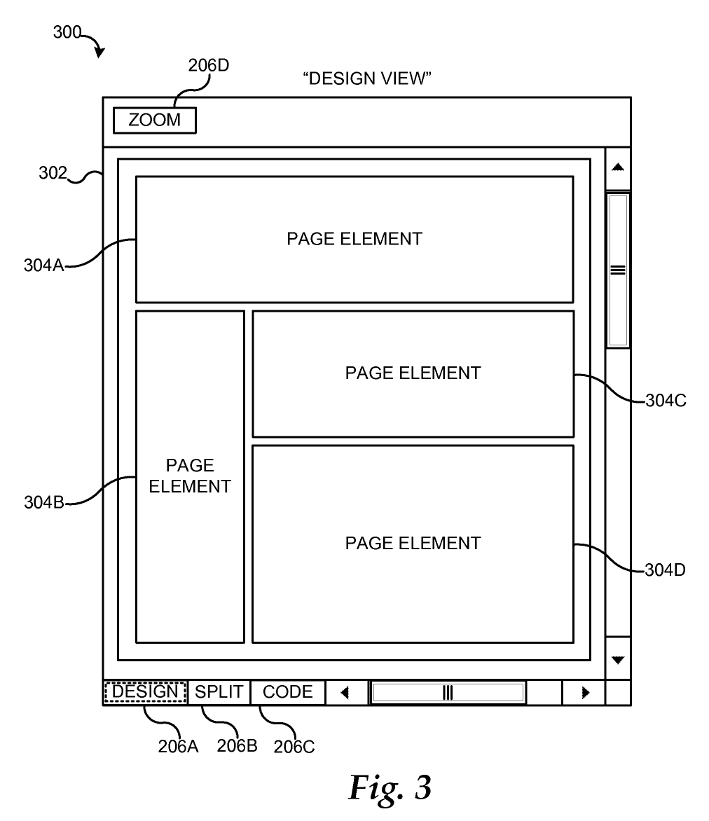

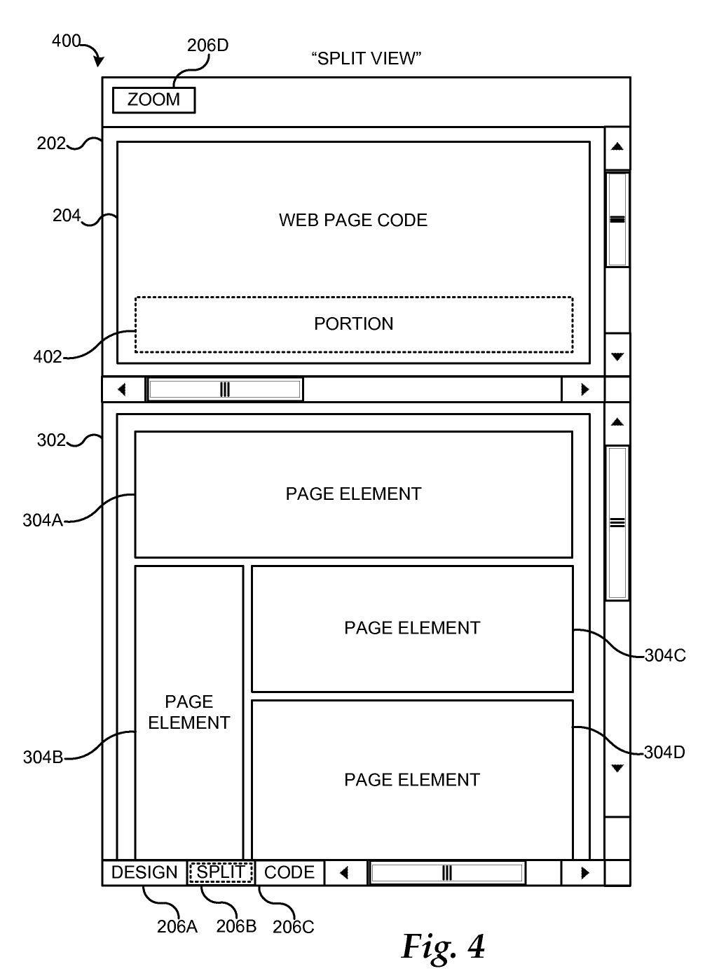

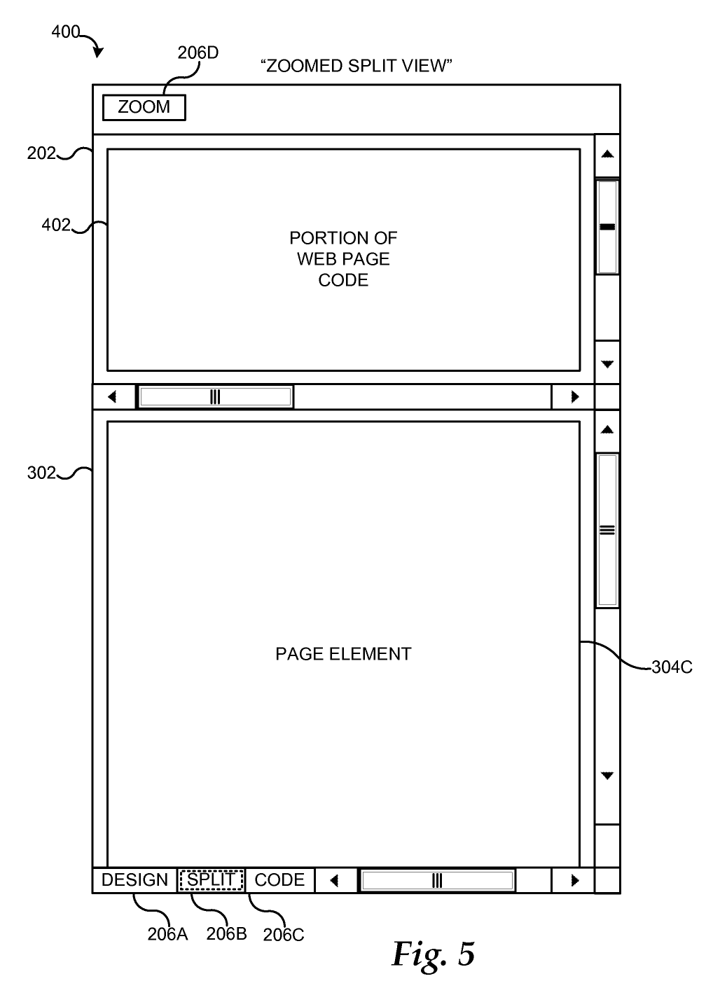

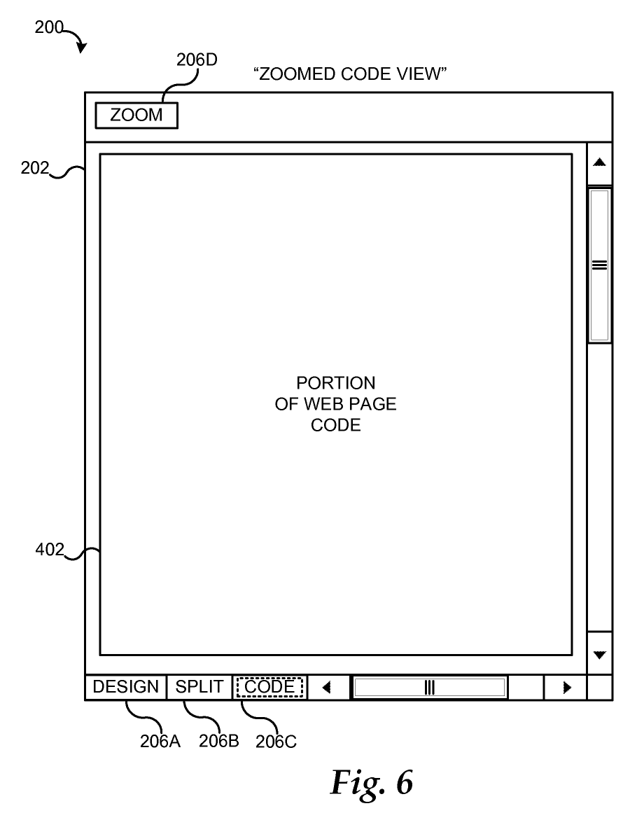

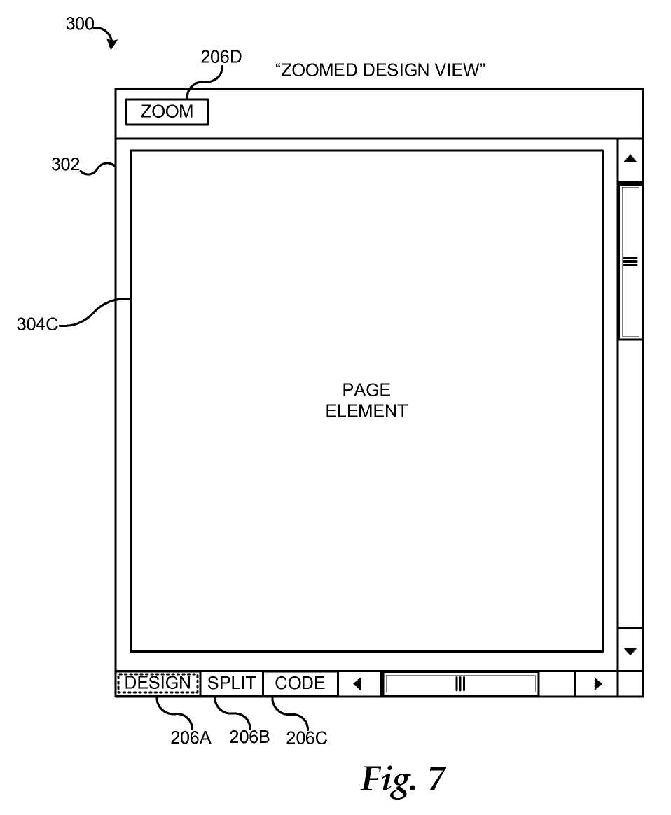

In order to facilitate the editing of a Web page 112, the editor 116 provides several user interfaces for editing code and page elements. In particular, according to one embodiment, the editor 116 provides a split view user interface, a code view user interface, and a design view user interface. As will be discussed in greater detail below, the split view user interface includes one section that shows the code of the Web page and another section that is utilized to display the rendered graphical page elements. As will also be discussed in greater detail below, the code view user interface provides a single section for showing the code, but does not display the rendered graphical page elements as in the split view user interface. The design view user interface provides a single section for showing the rendered graphical page elements, but does not display the code. Additional details regarding the split view user interface will be provided below with respect to FIGS. 4 and 5, details regarding the code view user interface will be provided below with respect to FIGS. 2 and 6, and details regarding the design view user interface will be provided below with reference to FIGS. 3 and 7.

As will also be discussed in greater detail below, the editor 116 also provides functionality for zooming into a specified scope within the code of the Web page 112 or the displayed page elements. As mentioned above, the term zooming refers to the process of rendering and displaying only a specified scope within the code and/or page elements. For instance, in one implementation, a user may select one of the page elements in the split view user interface and request to zoom into the page element. In response to such a request, the editor 116 renders and displays only the selected page element in the design section of the user interface. Additionally, only the code responsible for generating the selected page element is displayed and made available for editing in the code section of the user interface. Code and page elements outside the specified scope are not rendered or displayed. At any time, the user may request to zoom out of the selected page element, thereby showing all of the code and page elements.

According to one embodiment, a user may also select a portion of the code displayed in the code section of the split view user interface and request to zoom into the selected code. For instance, the selected code portion may comprise code for generating one of the page elements. In response thereto, the editor 116 displays only the selected code in the first section of the user interface. The editor 116 also renders and displays only the page element, or elements, generated by the selected code in the design section of the split view user interface. The user may request to zoom out of the selected code, thereby showing all of the code and page elements. Details regarding the functionality provided by the split view user interface in this regard are discussed below with respect to FIGS. 4 and 5.

Referring now to FIG. 2, additional details regarding one user interface provided by the editor 116 for editing a Web page 112 will be described. In particular, FIG. 2 shows the code view user interface 200 discussed briefly above. As shown in FIG. 2, the code view user interface 200 includes a single display section 202 for displaying the code 204 of the Web page 112 being edited. Through the use of appropriate user interface controls, a user can edit and otherwise modify the code 204 shown in the section 202. It should be appreciated that, at any given time, only a portion of the entire code of the Web page 112 may be displayed in the section 202. The editor 116 may provide appropriate user interface controls, such as the scroll bars illustrated in FIG. 2, for panning over the entire code of the Web page 112. In this regard, it should be appreciated that the particular user interface controls described herein are merely illustrative and that other types of user interface controls may be utilized.

As also shown in FIG. 2, the code view user interface 200 also includes the user interface buttons 206A-206D. Selection of the user interface buttons 206A-206C will cause the display provided by the editor 116 to change to another view. For instance, selection of the user interface button 206A will cause the display to switch to the design view user interface mentioned briefly above and described in detail below with respect to FIGS. 3 and 7. Selection of the user interface button 206B will cause the display to switch to the split view user interface mentioned briefly above and described in greater detail below with respect to FIGS. 4 and 5. Selection of the user interface button 206C while in another one of the views will cause the display to switch to the code view user interface shown in FIGS. 2 and 6.

According to embodiments presented herein, selection of the user interface button 206D will cause the code view user interface 200 shown in FIG. 2 to zoom into a specified scope within the code 204. In this regard, a user may utilize an appropriate user input device to select the scope of the code 204 that should be zoomed into. For instance, a user may utilize a mouse or keyboard to select a portion of the code 204. Alternately, the scope of the code 204 that should be zoomed into may be determined from the location of an insertion point within the code. According to embodiments, the scope is limited to particular sections or elements within the code 204. As an example, the scope may be limited to a portion of the code that renders a page element. In this manner, the editor 116 provides limited-scope rendering of a Web page 112.

Once the zoom scope has been specified and a user selects the user interface button 206D, the section 202 of the code view user interface 200 is modified to display only the portion of the code within the selected scope. Code outside the selected scope is not displayed in the section 202. The user can edit the code within the selected scope while the display is zoomed in. In order to return to a view showing the entire code 204 of the Web page 112, the user may again select the button 206D or perform another type of pre-defined user input such as selecting an “escape” key. Any changes made to the Web page 112 while zoomed are automatically saved. There is no need for the user to manually save the changes. Additional details regarding the zooming of the code view user interface are provided below with respect to FIG. 6.

Turning now to FIG. 3, additional details regarding another user interface provided by the editor 116 for editing a Web page 112 will be described. In particular, FIG. 3 shows the design view user interface 300 discussed briefly above. As shown in FIG. 3, the design view user interface 300 includes a single display section 302 for displaying a rendering of the Web page 112 being edited. For instance, in the example shown in FIG. 3, the rendering of the Web page 112 generated by the editor 116 includes four page elements 304A-304D. Through the use of appropriate user interface controls, a user can edit and otherwise modify the page elements 304A-304D shown in the section 302. This type of functionality is commonly referred to as What You See Is What You Get (“WYSIWYG”) editing. It should be appreciated that, at any given time, only a portion of the rendering of the Web page 112 may be displayed in the section 302. The editor 116 may provide appropriate user interface controls, such as the scroll bars illustrated in FIG. 3, for panning over the entire rendering of the Web page 112.

As also shown in FIG. 3, the design view user interface 300 also includes the user interface buttons 206A-206C for changing views. The design view user interface 300 also includes the user interface button 206D. In the design view, the user interface button 206D causes the design view user interface 300 to be zoomed into a selected one of the page elements 304A-304D. For instance, using an appropriate user interface control, a user may select one of the page elements 304A-304D. The user may then select the user interface button 206D to zoom into the selected page element. In order to zoom into the selected page element, the editor 116 only renders the selected page element. Other, non-selected page elements are not rendered. Additionally, the selected page element may be rendered in a manner to fill the entire section 302, thereby maximizing the available area of the user interface 300. Additional details regarding this process are provided below with respect to FIG. 7.

Referring now to FIG. 4, additional details regarding another user interface provided by the editor 116 for editing a Web page 112 will be described. In particular, FIG. 4 shows the split view user interface 400 discussed briefly above. As shown in FIG. 4, the split view user interface 400 includes the display section 202 for displaying the code 204 and the display section 302 for displaying the rendering of the Web page 112 being edited. In the example shown in FIG. 4, the rendering of the Web page 112 generated by the editor 116 includes four page elements 304A-304D. Through the use of appropriate user interface controls, a user can edit and otherwise modify the page elements 304A-304D shown in the section 302. A user can also edit the code 204 shown in the section 202. The editor 116 may provide appropriate user interface controls, such as the scroll bars illustrated in FIG. 4, for panning over the code 204 shown in the section 202 and the rendering of the Web page 112 shown in the section 302.

As also shown in FIG. 4, the split view user interface 400 also includes the user interface buttons 206A-206C for changing views. The split view user interface 400 also includes the user interface button 206D. While in the split view user interface, selection of the user interface button 206D causes the split view user interface 300 to be zoomed into a selected one of the page elements 304A-304D or a selected portion 402 of the code 204. For instance, using an appropriate user interface control, a user may select one of the page elements 304A-304D. The user may then select the user interface button 206D to zoom into the selected page element. In order to zoom into the selected page element, the editor 116 only renders the selected page element. Non-selected page elements are not rendered. Additionally, the editor 116 only displays the portion 402 of the code 204 in the section 202 that is responsible for rendering the selected page element. The remainder of the code 204 is not displayed in the section 202.

As mentioned above, selection of the user interface button 206D may also cause the split view user interface 300 to be zoomed into a selected portion 402 of the code 204. For instance, using an appropriate user interface control, a user may select a portion 402 of the code 204. The user may then select the user interface button 206D to zoom into the selected portion 402. In order to zoom into the selected portion 402 of the code 204, the editor 116 only displays the selected portion 402 of the code 204 in the section 202. The remainder of the code 204 is not displayed in the section 202. Additionally, the editor 116 only renders the selected portion 402 of the code 204. In this manner, the editor 116 only renders and displays the page elements in the section 302 that are generated by the selected portion 402 of the code 204. FIG. 5 further illustrates this example.

FIG. 5 shows another view of the split view user interface 400. In this example, the portion 402 of the code 204 is responsible for generating the page element 304C. Moreover, the user interface shown in FIG. 4 has been utilized to select the portion 402 of the code 204. The user interface button 206D has also been selected to zoom the split view user interface 400 into the selected portion 402 of the code 204. In response to such a selection, the user interface shown in FIG. 5 is displayed. As shown in FIG. 5, the section 202 only includes a display of the portion 402 of the code 204. Additionally, the section 202 only includes the page element 304C generated by rendering and displaying the selected portion 402 of the code 204. The page element 304C has been rendered to fit the entire section 302. It should be appreciated that the screen display shown in FIG. 5 may also be generated by a selection of the page element 304C and a selection of the user interface button 206D. It should also be appreciated that a user may return to the display shown in FIG. 4 through another selection of the user interface button 206D.

According to embodiments, the editor 116 provides functionality for moving between the code view user interface, the design view user interface, and the split view user interface while zoomed in to a portion of the code 204 or a page element 304. For instance, if a user selects the user interface button 206C while the screen display shown in FIG. 5 is displayed, the code view user interface 200 shown in FIG. 6 will be displayed. As is illustrated in FIG. 6, the code view user interface 200 is zoomed into the portion 402 of the code 204. If a user selects the user interface button 206A while the screen display shown in FIG. 5 is displayed, the design view user interface 300 shown in FIG. 7 will be displayed. As shown in FIG. 7, the section 302 of the design view user interface 302 is zoomed into the page element 304C. It should be appreciated, therefore, that the editor 116 provided herein in embodiments includes functionality for zooming into and out of a scope of the Web page 112 within each of the view modes and permits moving between the view modes while zoomed in or out. There is no need to save any modifications prior to zooming out or between views.

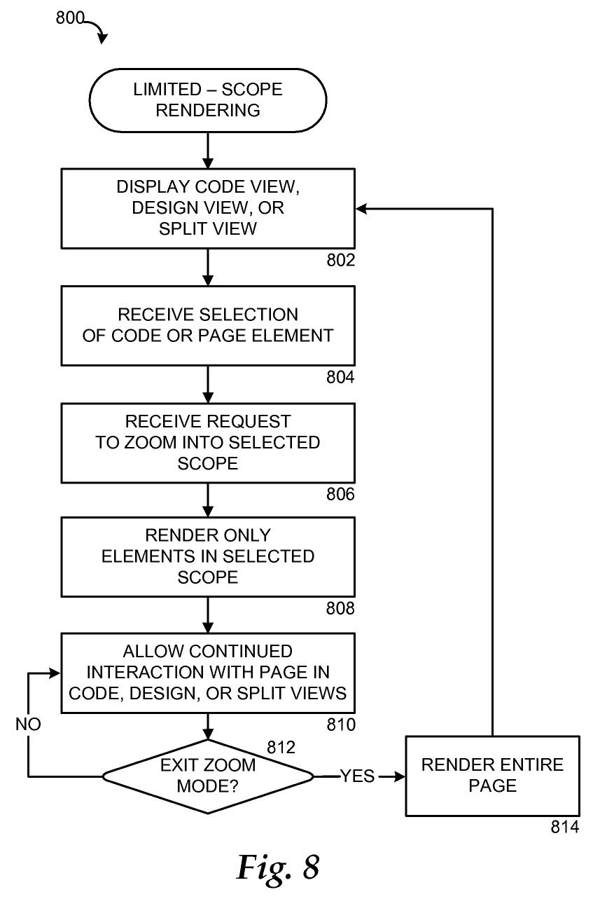

Referring now to FIG. 8, additional details will be provided regarding the embodiments presented herein for limited-scope rendering. In particular, FIG. 8 is a flow diagram illustrating aspects of the operation of the editor 116 for providing functionality for limited-scope rendering. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 800 begins at operation 802, where the editor 116 displays the code view user interface 200, the design view user interface 300, or the split view user interface 400. While any of these user interfaces are shown, a user is permitted to edit the code 204, the page elements 304, or both, in the manner described above. From operation 802, the routine 800 continues to operation 804, where the editor 116 receives a selection of a portion of the code 204 or one of the page elements 304. The routine 800 then continues to operation 806.

At operation 806, the editor 116 receives a request to zoom into a specified scope of the Web page 112 defined by the selected portion 402 of the code 204 or the selected page element 304. As discussed above, the user interface button 206D or another user interface control may be utilized to provide the zoom request. In response to receiving the zoom request, the routine 800 continues to operation 808, where the editor 116 renders only the elements within the selected scope. For instance, if a portion 402 of the code 204 is selected, only the code portion will be rendered and displayed in the manner described above. If one of the page elements 304 is selected, only the selected page element will be rendered and displayed and only the code corresponding to the selected page element will be shown in the code and split view user interfaces as discussed above. Once the zooming operation has been performed, the routine 800 continues to operation 810.

At operation 810, the user is permitted to continue editing the Web page 112 while the user interface is zoomed in. In the code view user interface 200, the user can edit the code 204. In the design view user interface 300, the user can edit the page elements 304. In the split view user interface 400, the user can edit both the code 204 and the page elements 304.

From operation 810, the routine 800 continues to operation 812, where a determination is made as to whether the user has requested to zoom out. If not, the routine 800 returns to operation 810, where additional editing is permitted. If so, the routine 800 proceeds to operation 814, where the entire Web page 112 is rendered and the rendering and/or the code 204 are displayed depending upon the current view. From operation 814, the routine 800 returns to operation 802, where the above-described process is repeated.

It should be appreciated that, according to embodiments, the page elements 304 may be organized into groups, such as by a container object or content placeholder in the Web page 112. In this embodiment, a user may select the placeholder and request to zoom into the page element, or elements, within the selected placeholder. When received in the split view user interface 400, such a request will cause only the code 204 responsible for generating the page elements 304 within the selected placeholder to be displayed in the section 202. Only the page elements 304 within the selected placeholder will be rendered and displayed in the section 302.

It should also be appreciated that zoomed page elements 304 are rendered in the proper context within the Web page 112 even if the page elements 304 have parent content that is not rendered because it is outside of the rendered scope. For instance, some Web technologies, like contextual cascading style sheets (“CSS”) and ASP.NET, depend upon an object's hierarchy within the page or upon the interaction of multiple page elements and their respective properties. The editor 116 maintains a tree that includes full information on all of the elements within the Web page 112 so that these technologies will still function as expected even if content they depend upon is out of the rendered scope of the Web page 112.

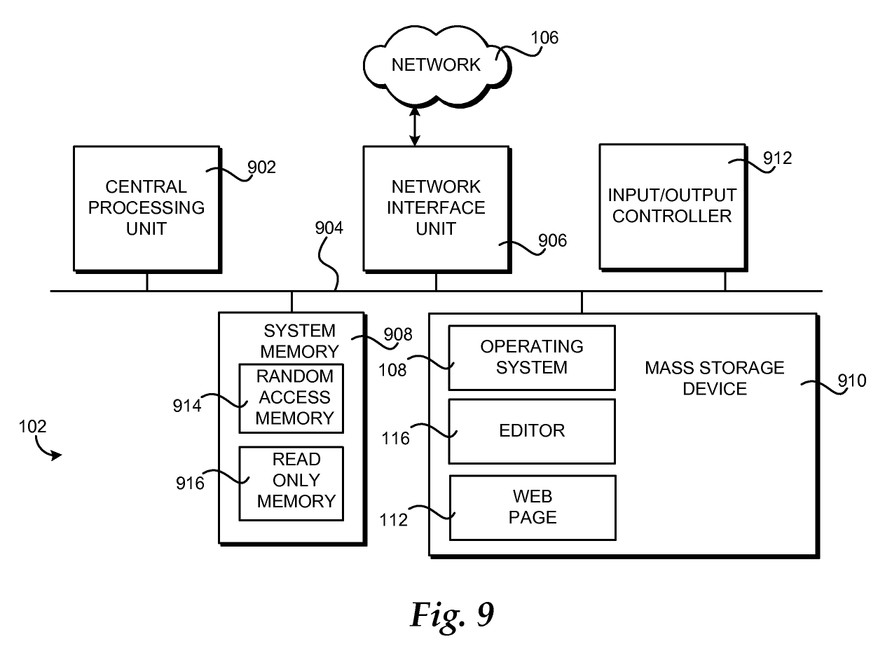

FIG. 9 shows an illustrative computer architecture for the client computer 102. As discussed above, the client computer 102 is capable of executing the software components described herein for limited-scope rendering. In particular, the computer architecture shown in FIG. 9 illustrates a simplified architecture for a conventional desktop, laptop, or server computer that may be utilized to execute any aspects of the software components presented herein. It should be appreciated that the computer architecture shown in FIG. 9 may also be utilized to embody the server computer 104.

The computer architecture shown in FIG. 9 includes a central processing unit 902 (“CPU”), a system memory 908, including a random access memory 914 (“RAM”) and a read-only memory (“ROM”) 916, and a system bus 904 that couples the memory to the CPU 902. A basic input/output system containing the basic routines that help to transfer information between elements within the client computer 102, such as during startup, is stored in the ROM 916. The client computer 102 further includes a mass storage device 910 for storing an operating system 108, application programs, and other program modules, which are described in greater detail herein.

The mass storage device 910 is connected to the CPU 902 through a mass storage controller (not shown) connected to the bus 904. The mass storage device 910 and its associated computer-readable media provide non-volatile storage for the client computer 102. Although the description of computer-readable media contained herein refers to a mass storage device, such as a hard disk or CD-ROM drive, it should be appreciated by those skilled in the art that computer-readable media can be any available computer storage media that can be accessed by the client computer 102.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the client computer 102.

According to various embodiments, the client computer 102 may operate in a networked environment using logical connections to remote computers such as the server computer 104 through a network such as the network 106. The client computer 102 may connect to the network 106 through a network interface unit 906 connected to the bus 904. It should be appreciated that the network interface unit 906 may also be utilized to connect to other types of networks and remote computer systems. The client computer 102 may also include an input/output controller 912 for receiving and processing input from a number of other devices, including a keyboard, mouse, or electronic stylus (not shown in FIG. 9). Similarly, an input/output controller may provide output to a display screen, a printer, or other type of output device (also not shown in FIG. 9).

As mentioned briefly above, a number of program modules and data files may be stored in the mass storage device 910 and RAM 914 of the client computer 102, including an operating system 108 suitable for controlling the operation of a networked desktop, laptop, or server computer. The mass storage device 910 and RAM 914 may also store one or more program modules and associated data. In particular, the mass storage device 910 and the RAM 914 may store the editor 116 and the Web page 112, each of which has been described in detail above with respect to FIGS. 1-8. The mass storage device 910 and the RAM 914 may also store other types of program modules.

Based on the foregoing, it should be appreciated that technologies for limited-scope rendering are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for the limited-scope rendering of a document comprising code for generating one or more page elements, the method comprising:
displaying the code in a first section of a user interface;
rendering the code to generate the one or more page elements
displaying the generated page elements in a second section of the user interface;
receiving a selection of one of the page elements displayed in the second section of the user interface;
receiving a request to render only the selected page element; and
in response to receiving the request to render only the selected page element, displaying only the selected page element in the second section of the user interface and displaying a portion of the code corresponding only to the selected page element in the first section of the user interface.

2. The method of claim 1, further comprising:
receiving a selection of a portion of the code displayed in the first section of the user interface;
receiving a request to render only the selected portion of the code; and
in response to receiving the request to render only the selected portion of the code, displaying only the selected portion of the code in the first section of the user interface and rendering the selected portion of the code to display only one or more of the page elements in the second portion of the user interface that correspond to the selected portion of the code.

3. The method of claim 1, wherein the code comprises wherein the code comprises one or more of ASP.NET code, HTML, CSS, XSL, FLASH, SILVERLIGHT, or JAVASCRIPT.

4. The method of claim 1, further comprising:
receiving a request to display only the code; and
in response to receiving the request to display only the code, displaying only the first section of the user interface.

5. The method of claim 4, further comprising providing functionality for editing the code in the first section of the user interface.

6. The method of claim 1, further comprising:
receiving a request to display only the page elements; and
in response to receiving the request to display only the page elements, displaying only the second section of the user interface.

7. The method of claim 6, further comprising providing functionality for editing the page elements in the second section of the user interface.

8. A computer storage medium having computer executable instructions stored thereon which, when executed by a computer, cause the computer to:
provide a user interface for editing a document having code stored therein for generating one or more graphical page elements, the user interface comprising a first portion and a second portion;
display the code in the first portion;
render the code to generate the one or more graphical page elements;
display the one or more graphical page elements in the second portion;
receive a selection of a one of the graphical page elements displayed in the second portion;
receive a request to zoom into the selected graphical page element; and
in response to receiving the request to zoom into the selected graphical page element, to display only the selected graphical page element in the second portion of the user interface and to display only a code portion corresponding to the selected graphical page element in the first portion of the user interface.

9. The computer storage medium of claim 8, having further computer executable instructions stored thereon which, when executed by the computer, cause the computer to:
receive a selection of a portion of the code displayed in the first portion of the user interface;
receive a request to zoom into the selected portion of the code; and
in response to receiving the request to zoom into the selected portion of the code, displaying only the selected portion of the code in the first portion of the user interface and rendering the selected portion of the code to display only the graphical page elements that correspond to the selected portion of the code in the second portion of the user interface.

10. The computer storage medium of claim 8, wherein displaying the selected graphical page element comprises rendering the selected graphic page element to fill the second portion of the user interface.

11. The computer storage medium of claim 10, having further computer executable instructions stored thereon which, when executed by the computer, cause the computer to:
receive a request to display only the code; and
in response to the request to display only the code, to remove the second portion of the user interface thereby displaying only the code in the user interface.

12. The computer storage medium of claim 11, having further computer executable instructions stored thereon which, when executed by the computer, cause the computer to provide functionality for editing the code displayed in the first portion of the user interface.

13. The computer storage medium of claim 12, having further computer executable instructions stored thereon which, when executed by the computer, cause the computer to:
receive a request to display only the graphical page elements; and
in response to the request to display only the graphical page elements, removing the first portion of the user interface, thereby displaying only the graphical page elements in the user interface.

14. The computer storage medium of claim 13, having further computer executable instructions stored thereon which, when executed by the computer, cause the computer to provide functionality for editing the graphical elements displayed in the second portion of the user interface.

15. The computer storage medium of claim 14, wherein the code comprises one or more of ASP.NET code, HTML, CSS, XSL, FLASH, SILVERLIGHT, or JAVASCRIPT.

16. A method for the limited-scope rendering of a World Wide Web page comprising code for generating one or more page elements, the method comprising:
providing a split view user interface comprising a first section showing the code and a second section showing the page elements;
receiving a request to zoom into a portion of the code; and
in response to the request to zoom into the portion of the code, displaying only the portion of the code in the first section and displaying one or more of the page elements generated by the portion of the code in the second section.

17. The method of claim 16, further comprising:
receiving a request to zoom out of the portion of the code; and
in response to the request to zoom out of the portion of the code, displaying the code in the first section and displaying the one or more page elements in the second section.

18. The method of claim 17, further comprising:
receiving a request to zoom into a selected one of the page elements; and
in response to the request to zoom into the selected one of the page elements, displaying a portion of the code corresponding to the selected one of the page elements in the first section and displaying only the selected one of the page elements in the second section.

19. The method of claim 18, further comprising:
providing a code view user interface comprising a single display section for displaying the code;
receiving a request to zoom into a portion of the code displayed in the code view user interface; and
in response to receiving the request to zoom into the portion of the code displayed in the code view user interface, displaying only the portion of the code in the single display section for displaying the code.

20. The method of claim 19, further comprising:
providing a design view user interface comprising a single display section for displaying the page elements;
receiving a request to zoom into one a selected one of the page elements displayed in the design view user interface; and
in response to receiving the request to zoom into one a selected one of the elements displayed in the design view user interface, displaying only the selected one of the page elements in the single display section for displaying the page elements.
